(19) United States
(12) Patent Application Publication
(10) Pub. No.: US 2003/0110044 A1
(43) Pub. Date: Jun. 12, 2003

(54) Distributed resource metering system for billing

(76) Inventors: John A. Nix, Chicago, IL (US); Michael H. Rubin, Evanston, IL (US); Andrew W. Kwong, Naperville, IL (US)

Correspondence Address: Marcus J. Thymian, McDonnell Boehnen Hulbert & Berghoff, 32nd Floor, 300 S. Wacker Drive, Chicago, IL, 60606, US

(21) Appl. No.: 10/008,331

(22) Filed: Dec. 6, 2001

(51) Int. Cl. G06F 17/60

(52) U.S. Cl. 705/1; 705/40

(57) ABSTRACT

A distributed resource metering system provides a billing component on a billing client, a billing server, and at least one database. The distributed resource metering system provides billing data in substantially real time. The billing client and the billing server are linked to a network, such as the Internet. The billing server authorizes the billing client to access a service. The billing client communicates with a gateway or another billing client. The billing server monitors the communication and provides substantially real time billing data to a display on the billing client.

### FIELD

The present invention relates to billing systems. More particularly, the present invention relates to a distributed resource metering system used for billing.

### BACKGROUND

Practically everyone is familiar with receiving monthly bills for services such as phone, natural gas, and electricity. While some bills may be a flat monthly rate, many bills are for an amount that is reflective of the quantity of services used. Companies that are paid based upon the amount of services consumed must have a method of determining an individual's usage rate. In addition, it is now more common for companies to provide pre-paid services. Companies providing pre-paid services need to provide a method of informing consumers how much of the service is remaining and how to purchase additional service.

Utility companies typically have meters that track the amount of natural gas, electricity, or water that is used by a facility. Usage bills are typically generated monthly based on meter readings. Phone companies have traditionally generated a call detail record (CDR) for each call made. The CDR contains the originating number, the receiving number, the start time, and the end time. This information is stored in a database. The phone company then downloads the information to determine how much each of the calls cost, which is based on the type of call and the customer's calling plan. Typically, the phone company will bill the customer once a month.

Companies that provide services over the Internet also need a method of billing for their services. Many different devices can access the Internet, such as computers, mobile phones, wireless handheld devices, and packet-switched telephones. These devices can be used to access a variety of media channels, such as voice, video, instant messaging, Web browsing, and file downloading. Because there are so many different types of devices that can connect to the Internet and there are so many different media channels that these devices can access, companies providing these services need a billing system that allows for flexibility. Current billing programs are typically located behind a gateway so that the customer has no access to their real time account information. These billing programs download the billing information in a batch, similar to phone companies. While some companies may perform downloads more frequently than once a month so that customers can view their account on line, the information is not provided in real time.

It would be desirable to have a distributed resource metering system that provides real time billing information to consumers. By providing information to consumers regarding the quantity of services used and the associated costs in real time, they can make educated decisions regarding how to spend their money.

If the consumer has purchased a pre-paid amount of service, it would be desirable to inform consumers how much of the service is still available and how to purchase additional services prior to depleting the account. It would also be desirable to cut off services to a pre-paid customer who has depleted their account.

It would be desirable to provide application billing. A customer may be charged one rate for making a phone call and a different rate for downloading a game. The rate for the phone call may be based on time and location, while a rate for downloading a game may be based on the number of bits downloaded, unrelated to the time it took or the location of the file.

### BRIEF DESCRIPTION OF THE DRAWINGS

Various embodiments are described with reference to the following drawings, wherein:

FIG. 1 is a simplified block diagram illustrating an exemplary distributed resource metering system;

FIG. 2 is a simplified block diagram illustrating an exemplary billing client;

FIG. 3 is an illustration of a display, according to an exemplary embodiment;

FIG. 4 is a simplified block diagram illustrating an exemplary billing server;

FIG. 5 is a simplified illustration of a service manager, according to an exemplary embodiment;

FIG. 6 is a simplified block diagram illustrating an exemplary distributed resource metering system;

FIG. 7 is a simplified block diagram illustrating an exemplary distributed resource metering system;

FIG. 8 is a modeling diagram for a startup sequence, according to an exemplary embodiment;

FIG. 9 is a modeling diagram for resource metering, according to an exemplary embodiment;

FIG. 10 is a modeling diagram for resource termination, according to an exemplary embodiment;

FIG. 11 is a simplified message flow diagram illustrating an exemplary distributed resource metering method; and

FIG. 12 is a simplified block diagram summarizing an exemplary distributed resource metering method.

### DETAILED DESCRIPTION

I. Distributed Resource Metering System Components

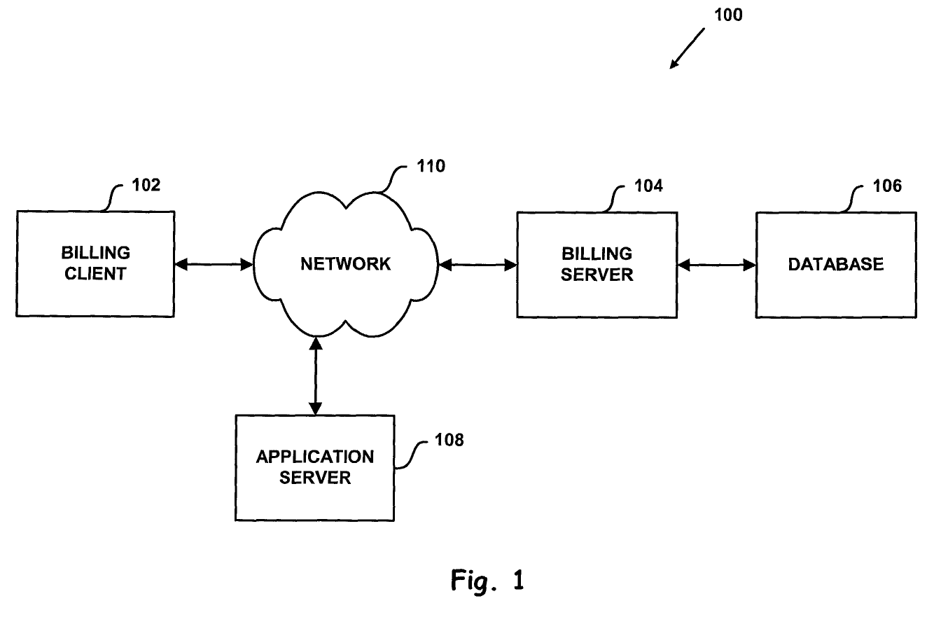

FIG. 1 is a simplified block diagram illustrating an exemplary distributed resource metering system 100. The distributed resource metering system 100 may include a billing client 102, a billing server 104, at least one database 106, and an application server 108. The billing client 102, the billing server 104 and the application server 108 may be linked to a network 110. The network 110 may be a packet-switched network, such as the Internet or some other physical and/or wireless network. The network 10 may be a public or a private network. The billing server 104 may be linked to the at least one database 106. Alternatively, the at least one database 106 may be a component of the billing server 104.

A. Billing Client

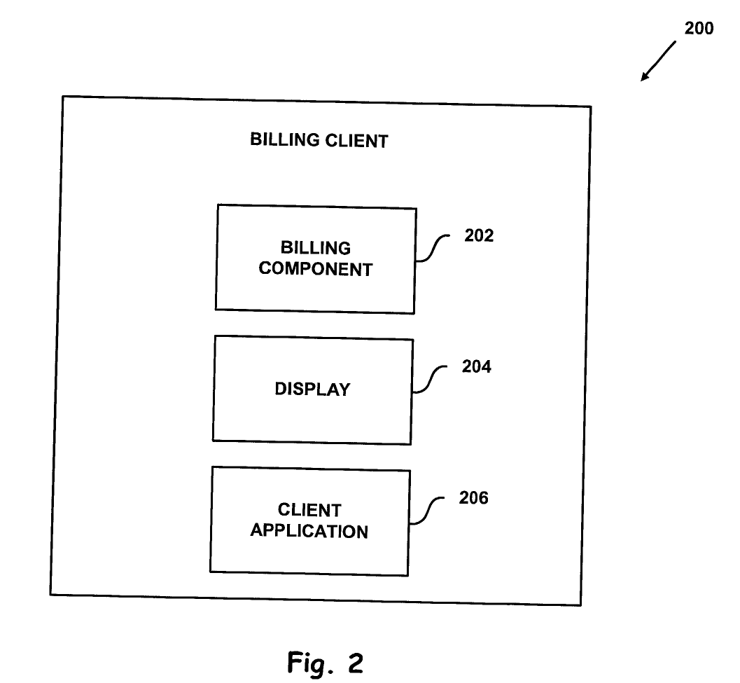

FIG. 2 is a simplified block diagram illustrating an exemplary billing client 200. The billing client 200 may be substantially the same as the billing client 102 of the distributed resource metering system 100. The billing client 200 is shown as a simple rectangular box in FIG. 2 to emphasize the variety of different forms the billing client 200 might take on from one embodiment to the next. For example, the billing client 200 might be any one of the following: a personal computer (PC), a mobile phone, a wireless handheld device, or a packet-switched telephone. The billing client 200 is not limited to any of these devices, and is intended to encompass future communication and information technology.

The billing client 200 may contain a billing component 202, a display 204, and a client application 206. The billing client 200 may contain other client components, such as such as a phone pad, a keyboard, or a video screen. In addition, the billing client 200 may contain an application that allows the billing client 200 to communicate with the application server 108. Although the billing component 202, the display 204, and the client application 206 are shown to be physically located within the billing client 200, other configurations may also be used.

The billing client 200 may have at least one link to the network 110. The billing client 200 may connect to the application server 108 through the network 110 employing phone gateways and network routers. The billing client 200 may be capable of accessing the Internet and executing a program to communicate with the billing server 104.

The billing component 202 may contain software containing at least one program or routine that provides a means for the billing client 200 and the billing server 104 to communicate with each other. The billing component 202 may be a Java applet running within a Java Virtual Machine, an Active-x control, a Microsoft DLL, or a SUO for Unix systems. The Java language is merely one implementation, and other languages and module types are also intended to be within the scope of the present system. The billing client 200 may communicate with the billing server 104 through any standard Internet communication protocol in place of Java serialized objects, such as Microsoft.NET platform, Sun Web Services, XML, and CORBA.

The software in the billing component 202 may be encrypted. The billing component 202 may contain a decoder that interprets the encrypted software. For example, if the billing component 202 is a Java applet, the billing component 202 may be compiled byte-code. The byte-code may be a binary file containing an executable program that may be interpreted by the Java Virtual Machine. While the billing component 202 is preferably software-based, one or more components may include hardware or firmiware aspects.

The billing component 202 may be upgraded, or otherwise modified, by transferring a new version of the billing component 202 to the billing client 200 after an end user activates the billing client 200. For example, after the end user activates the billing client 200, the billing server 104 may check a flag to determine what version of the billing component 202 is loaded on the billing client 200. If the latest version is not loaded, the billing server 104 may transfer the latest version of the billing component 202 onto the billing client 200.

The display 204 may contain a Graphical User Interface (GUI). The GUI may be customizable for the particular type of billing client 200. For example, the GUI on a cell phone may just display text, while the GUI on a computer may display a full range of graphics. The end user may be able to view substantially real time billing data. For example, while using services on the Internet, the end user may be able to see the duration and the cost of the service change on the display 204 in substantially real time. The end user may be able to view account information, such as how much a particular service will cost or how much was billed in the last thirty days, from the display 204. The end user may also be able to access an address book, add funds to his account, and send and/or receive instant messages from the display 204.

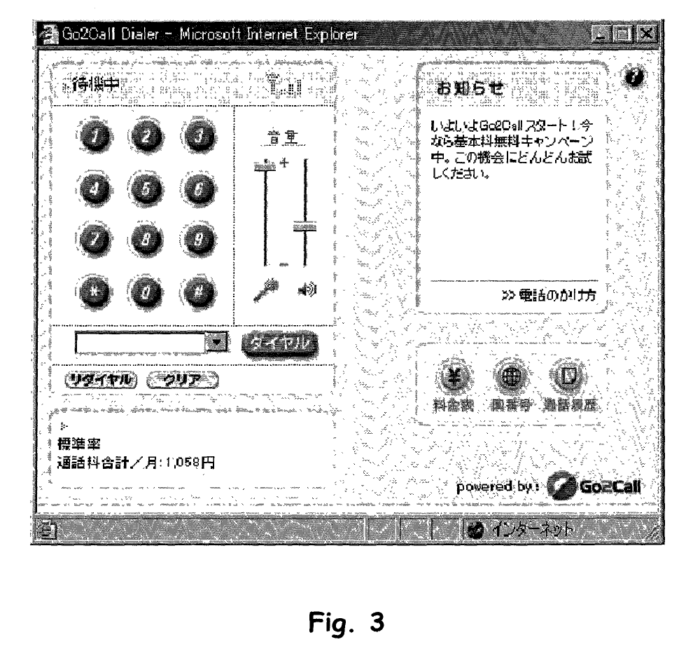

FIG. 3 provides an illustration of the display 204, according to an exemplary embodiment. The display shown in FIG. 3 may be a typical display format. The text is in Japanese to demonstrate that the distributed resource metering system 100 may be used with many different languages and currencies.

The client application 206 may be any application server that requires resource metering. The client application 206 is depicted in FIG. 2 as being located within the billing client 200 to demonstrate that the application server may be integrated within the billing client 200. However, the client application 206 may be located separately from the billing client 200, such as the application server 108. The client application 206 may be operable to access and integrate with any number of services.

B. Billing Server

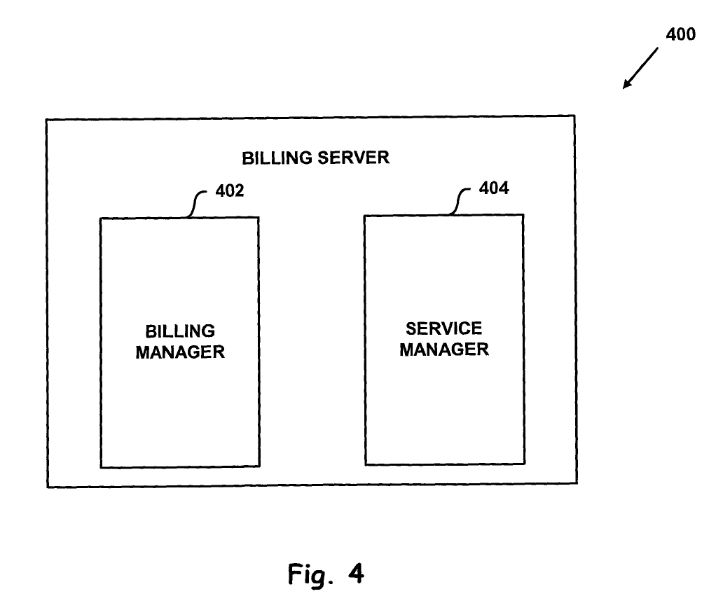

FIG. 4 is a simplified block diagram illustrating an exemplary billing server 400. The billing server 400 may be substantially the same as the billing server 104 of the distributed resource metering system 100. The billing server 400 is shown as a simple rectangular box in FIG. 4 to emphasize the variety of different forms the billing server 400 might take on from one embodiment to the next. The billing server 400 may be an application server, which may contain a combination of hardware, software, and/or firmware. In an exemplary embodiment, the billing server 400 may be a WebLogic Server manufactured by BEA Systems, Inc. of San Jose, Calif. However other servers, such as Tomcat/Jakart, IBM Web Sphere, Allaire's JRun, or iPlanet Application Server, may also be employed.

The billing server 400 may include a billing manager 402 and a service manager 404. The billing server 400 may include other components. The billing server 400 may have at least one link to the network 110. The billing server 400 may also have at least one link to the at least one database 106. The billing server 400 may support multiple languages and currencies.

The billing manager 402 may manage data between the billing client 102 and the at least one database 106. In an exemplary embodiment, the billing manager 402 may be a Java servlet. Other methods of managing data may be employed, including various combinations of software, hardware, and/or firmware. The billing manager 402 may receive a request from the billing client 102, access the requested information from the at least one database 106, and return the requested information to the billing client 102. The billing manager 402 may track all active end users employing the application server 108, which may be managed by service manager 404.

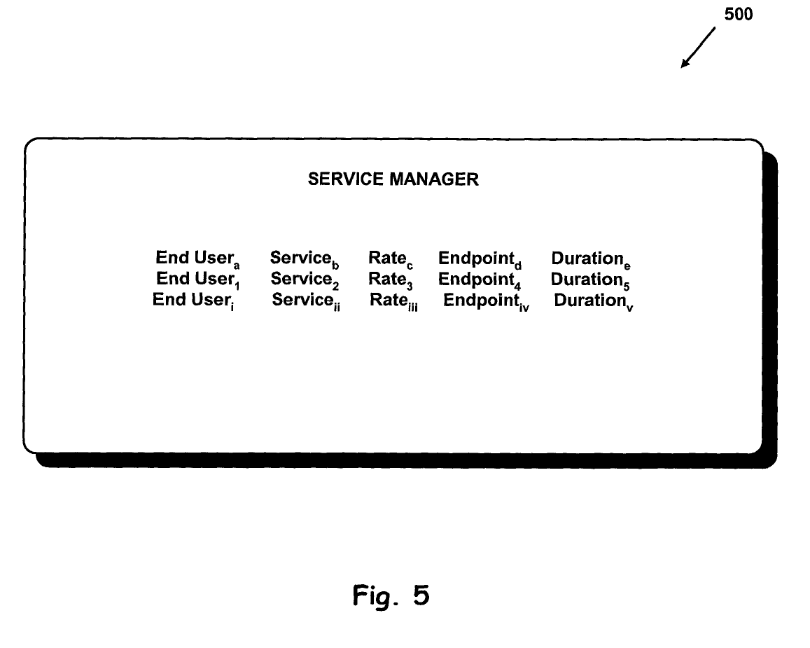

FIG. 5 shows a simplified illustration of the service manager 500 in an exemplary embodiment. The service manager 500 may be substantially the same as the service manager 404 of the billing server 400. The service manager 500 may be a collection that includes a list of substantially all the active end users. The collection may be stored in memory located on the billing server 400. For example, the collection may be stored in a hash table. The end user may access more than one media channel at a time. A record in the service manager 500 may represent an individual service request from one or more end users. Data located in the service manager 500 may include: the end user, the type of service requested, the associated rate for the combination of end user and service, the endpoint, and the duration. Other fields may also be located in the service manager 500. For example, one of the records in the service manager 500 may identify: the end user, that the end user accessed a Web page to download a game, that the end user's rate for downloading a game is ten cents a minute, and that it took five minutes to down load the game. The duration field would change substantially in real time as the download progressed.

The billing server 400 may monitor communications between the billing client 102 and either a gateway or another billing client. The billing server 400 may monitor the duration, quality, and type of service. Other service characteristics may also be monitored. By tracking the duration of the service, the billing server 400 may bill the end user for only the amount of service that was consumed. By tracking the quality of the service, the billing server 400 may be able to adjust the bill if poor quality was detected. By tracking the type of service, the billing server 400 may provide application billing. For example, there may be one rate for a phone call and another rate for downloading a game from the Internet. The rate for the phone call may vary based on the rate plan assigned to the end user, the time of the day that call was made, the duration of the call, and/or the location of the end user receiving the call. The rate for downloading a game may be based on the location of the game, the time it took to perform the download, and/or the total number of bits downloaded.

In an exemplary embodiment, the communication between the billing client 102 and billing server 400 may be performed using encrypted HyperText Transfer Protocol (HTTP). Other methods of secured communication compatible with the network 110 may also be employed. By using the billing server 400 to manage the communication, the gateway may not be required for billing. The billing server 400 may provide the billing client 102 with gateway information for the service requested by the billing client 102.

The billing server 400 may receive a Resource Utilization Update (RUU) on a periodic basis to update the service manager 404 regarding the activities being resource metered. The period of the RUU may be increased or decreased based upon the billing interval employed by the distributed resource metering system 100. For example, if the period is set to one minute, the billing server 400 may receive the RUU every minute. The RUU may be used to determine when communications between the billing client 102 and the gateway has been terminated.

The RUU may be a program or routine used to determine if a particular network destination is online, such as a serialized Java object. A message may be transmitted on a regular interval, such as every minute, from the billing component 202 to the billing server 400. If the message stops being transmitted, the billing client 102 may no longer be connected to the network 110. The monitoring may allow the distributed resource metering system 100 to bill the end user for the actual amount of services consumed. For example, if the end user had indicated that he planned to make a thirty minute call and for some reason that call was interrupted after twenty-five minutes, the billing server 400 may detect that the call was interrupted and the end user would only be billed for the twenty-five minutes that was actually used.

When the billing client 102 is no longer active, the billing server 400 may delete the billing client 102 from the service manager 404. The billing information for the service may be stored in the at least one database 106.

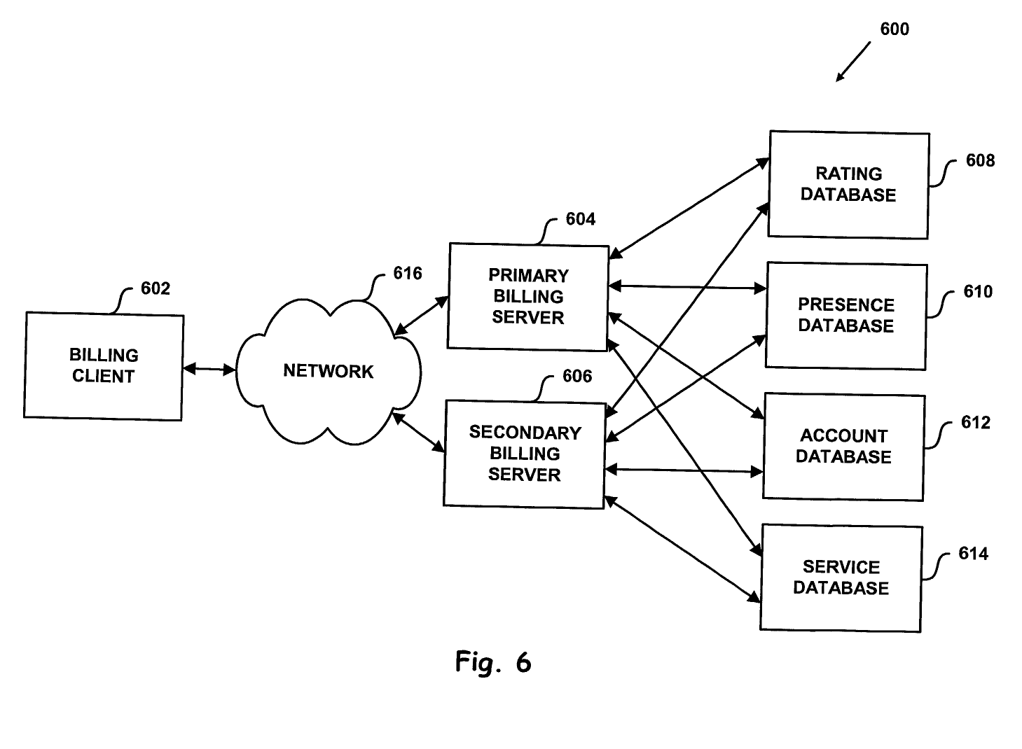

FIG. 6 is a simplified block diagram illustrating an exemplary distributed resource metering system 600. The distributed resource metering system 600 contains a primary billing server 604 and a secondary billing server 606. The secondary billing server 606 may be substantially the same as the primary billing server 604. Both the primary billing server 604 and the secondary billing server 606 may have access to the same databases.

If for some reason the billing client 602 is unable to communicate with the primary billing server 604, the billing client 602 may be transferred to the secondary billing server 606. The billing client 602 may attempt to communicate with the primary billing server 604. If the primary billing server 604 is not reached, the billing client 602 may be transferred to the secondary billing server 606. If the billing client 602 is unable to reach either the primary billing server 604 or the secondary billing server 606, then the billing client 602 may be unable to access the gateway.

Because the secondary billing server 606 may have access to the same databases as the primary billing server 604 and the RUU may contain substantially all the data that the secondary billing server 606 needs to populate its service manager 404, the secondary billing server 606 may be able to provide continuous monitoring and accurate billing for the service. By providing more than one billing server, the distributed resource metering system 600 may be redundant. Redundancy is an optional feature that may be provided to achieve various advantages, such as high availability. Other embodiments may include more than two billing servers.

C. Databases

The at least one database 106 may be a component of the billing server 104 or a separate entity from the billing server 104. In an exemplary embodiment, the at least one database 106 may be an Oracle database. However, other database products, such as IBM's DB2 or Microsoft's SQL Server or PostgreSQL, may also be used.

FIG. 6 shows that the distributed resource metering system 600 may contain multiple databases. The distributed resource metering system 600 is shown as having four databases; however, more or fewer databases are possible. It is also within the scope of this embodiment that the functions of one database may be included within another. An exemplary distributed resource metering system may contain one database with multiple tables. As shown, the distributed resource metering system 600 includes a rating database 608, a presence database 610, an account database 612, and a service database 614. Other databases or tables within a database may be used based on business needs.

The rating database 608 may contain rate information. There are a number of different rate plans that may be assigned to the end user. The end user may be charged a different rate for the amount and type of service. A pre-paid account may pay a different rate than an account that is invoiced after the service has been consumed. Rates may vary based on where the service originates and where the receiving end user is located. Rates may vary for different types of service, such as phone calls, video conferencing, or downloading games. Rates may vary for different quantities of service. For example, a large quantity discount rate may be available.

The rating database 608 may also contain currency and exchange rate information. This may allow the distributed resource metering system 600 to provide billing information for services in the currency of the end user's country. For example, the end user may be a citizen of England. The distributed resource metering system 600 may produce substantially real time billing information and invoices using the sterling pound as the currency.

The presence database 610 may contain substantially all of the connections to the network 616. If the billing client 602 wishes to communicate with another billing client, the presence database 610 may be able to determine whether the other billing client is connected to the network 616.

The account database 612 may contain information regarding an end user's account. When the service is terminated, the record stored in the service manager 404 may be transferred to the account database 612. The end user may have access to this record the next time he activates the billing client 602. A bill may be generated and sent to the end user using the data stored in the account database 612.

The service database 614 may contain a list of active services. The active services may include voice, video, instant messaging, and other media channels. Other services may be available. The service database 614 may contain gateway information, such as where the gateway is located and whether it is available.

D. Application Server

Referring back to FIG. 1, the application server 108 may be any application server that requires resource metering. The application server may be accessible through the network 110. Alternatively, the application server 108 may be accessible through a gateway connected to the network 110. For example, the application server 108 may be a game server. As the billing client 102 downloads games from the application server 108, the billing server provides resource metering to bill the end user for the cost of downloading the game.

II. Distributed Resource Metering System Operation

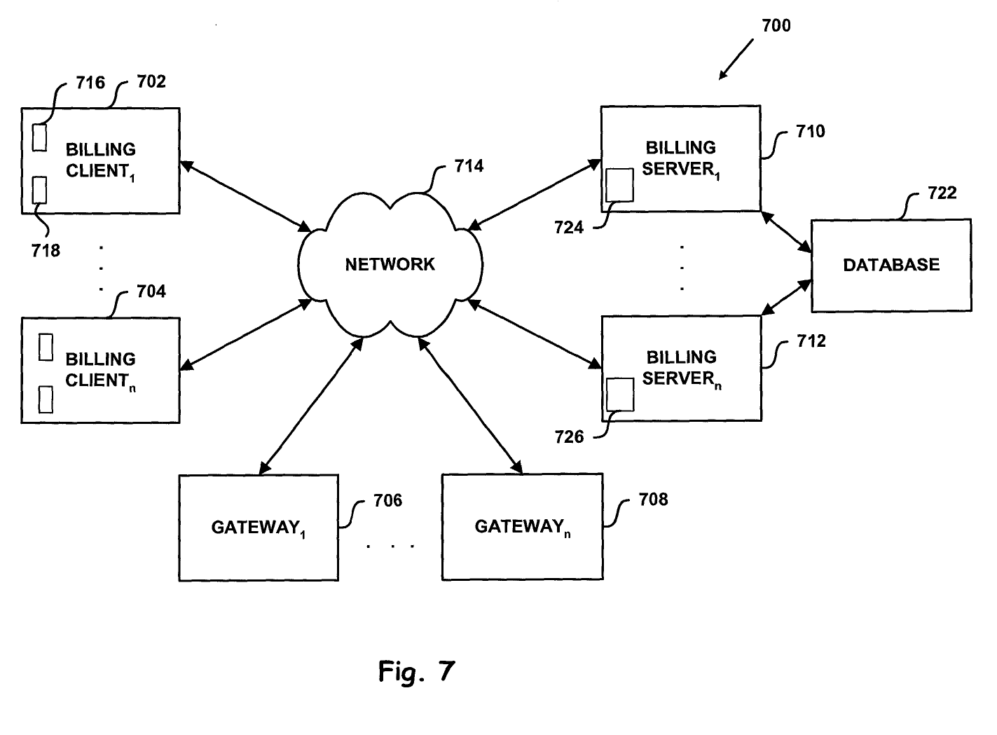

FIG. 7 is a simplified block diagram illustrating an exemplary distributed resource metering system 700. Distributed resource metering system 700 may contain at least one billing client 702, 704 and at least one billing server 710, 712. The at least one billing client 702, 704 and the at least one billing server 710, 712 may be linked to a network 714. The network 714 may be a packet-switched network, such as the Internet or some other physical and/or wireless network. The network 714 may be a public or a private network. At least one gateway 706, 708 may also be linked to the network 714.

A. Initialization

The end user may activate the billing client 702. Activation may occur when the end user turns on the billing client 702. Other methods of activation may also be possible. The billing client 702 may then run initialization routines. For example, the billing client 702 may launch a Java applet. The initialization routines may also run when the billing client 702 has lost and then finds its signal, such as when a cell phone travels through a tunnel. The billing client 702 may be connected to the network 714 during initialization.

The initialization routines may determine a format of a display 718. For example, the display 718 may have one format for a cell phone and a different format for a computer monitor. The format may also include language and currency preferences. End user preferences, such as weather, stock quotes, or game results, may also be formatted on the display 718.

The end user may begin service by using the display 718, a keyboard, a video screen, or a phone pad on the billing client 702. For example, the end user may use the display 718 to access an address book and then select a name from the address book with the intention of sending another billing client 704 an instant message.

A billing component 716 located on the billing client 702 may send a request for service message to the billing server 710. The request for service message may include the type of service the end user desires. Other information may be included in the request for service message, such as end user identification, end user name, end user preferences, and status information. In an exemplary embodiment, the message may be in the format of a serialized encrypted Java object; however, other message formats may be employed.

Communication between the billing client 702 and the billing server 710 may use HyperText Transfer Protocol (HTTP) and Transmission Control Protocol/Internet Protocol (TCP/IP) protocols. Other communication protocols that are compatible with the network 714 may also be employed. For example, the billing server 710 may be accessed as a web service. The billing client 702 may communicate to the billing server 710 using Simple Object Access Protocol (SOAP). The communication may also be available over a Universal Description Discovery and Integration (UDDI) directory using Web Services Description Language (WSDL).

The billing server 710 may verify that the billing client 702 has the most recent billing component 716. The billing server 710 may check a flag, such as a binary software variable, to determine what version of the billing component 716 is loaded on the billing client 702. If the latest version is not loaded, the billing server 710 may transfer the latest version of the billing component 716 onto the billing client 702.

The billing client 702 may desire to communicate with another billing client 704 or access a service through a media channel. Media channels may include, but are not limited to, voice, video, instant messaging, Web browsing, and file downloading. To access the media channel, the billing client 702 may use the at least one gateway 706, 708. Alternatively, the billing client 702 may access an application server directly, such as application server 108. In another embodiment, the client application may be located on the billing client 702.

The billing server 710 may receive the request for service message from the billing client 702. The billing server 710 may verify that the billing client 702 is authorized to make the service request. Verification may occur by accessing at least one database 722. The at least one database may be part of or separate from the billing server 710. If the billing client 702 is authorized, the billing server 710 may provide gateway information to the billing client 702. The billing client 702 may then access the media channel directly using the at least one gateway 706, 708. For example, the billing client 702 may make a request for a video conferencing service. The billing server 710 may authorize the billing client 702 for that type of service and send the billing client 702 information regarding gateway 706, which may provide video conferencing.

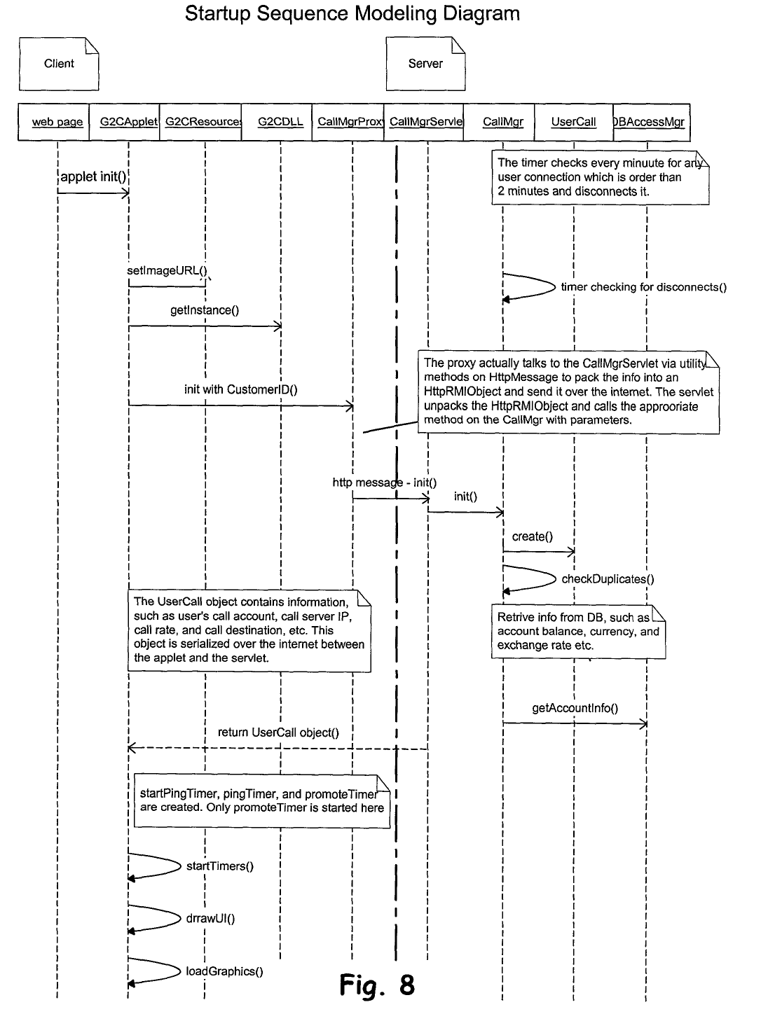

FIG. 8 is a modeling diagram for a startup sequence, according to an exemplary embodiment. FIG. 8 is provided as an example for a browser based Voice over Internet (VOIP) PC-to-phone application. The VoIP application (G2Capplet) implements the initialization process for communicating with the billing server (CallMgr Servlet) to track calling charges for a PC-to-phone application. Other startup sequences may be employed for PC-to-phone applications, as well as for other distributed resource metering system applications.

B. Resource Metering

The billing server 710 may monitor the communications between the billing client 702 and the at least one gateway 706, 708. The monitoring may be performed with a program or routine used to determine if a particular network destination is online, such as a serialized Java object. A message may be transmitted on a regular interval from the billing component 716 to the billing server 710. The billing server 710 may monitor whether the message stops being transmitted. If the message stops, the billing client 702 or the at least one gateway 706, 708 may no longer be connected to the network 714.

A Resource Utilization Update (RUU) may be used for monitoring. The RUU may be a serialized Java object; however, other methods of monitoring may be employed. In an exemplary embodiment, the RUU is transmitted to the billing server 710 every minute. The time may be increased or decreased based on a billing interval employed by the distributed resource metering system 700. The monitoring may allow the distributed resource metering system 700 to bill the end user for the actual amount of service used.

If for some reason the billing client 702 is unable to communicate with the billing server 710, the billing client 702 may be transferred to the billing server 712. The billing client 702 may not be aware of the transfer from the billing server 710 to the billing server 712. Because the billing server 712 may have access to the at least one database 722 and the RUU may contain substantially all the data that the billing server 712 needs to populate its service manager 726, the billing server 712 may be able to provide continuous monitoring and accurate billing for the service. By providing more than one billing server, the distributed resource metering system 700 may be redundant. Other embodiments may include more than two billing servers.

The billing server 710 may update its service manager 724. For example, the billing server 710 may change the duration field in the service manager 724 as the amount of service used increases. In addition, the billing server 710 may remove the billing client 702 from the service manager 724 when the billing client 702 is no longer connected to the network 714 or to the at least one gateway 706, 708. An update of the service manager 724 may occur during each billing interval.

During the service, the end user may be able to see the duration and the cost of the service change on the display 718 in substantially real time. The end user may also be able to view account information, such as how much a particular service will cost or how much was billed in last thirty days, from the display 718. The end user may also be able to detect that a pre-paid account is about to be depleted and may be able to fund the account for continued service.

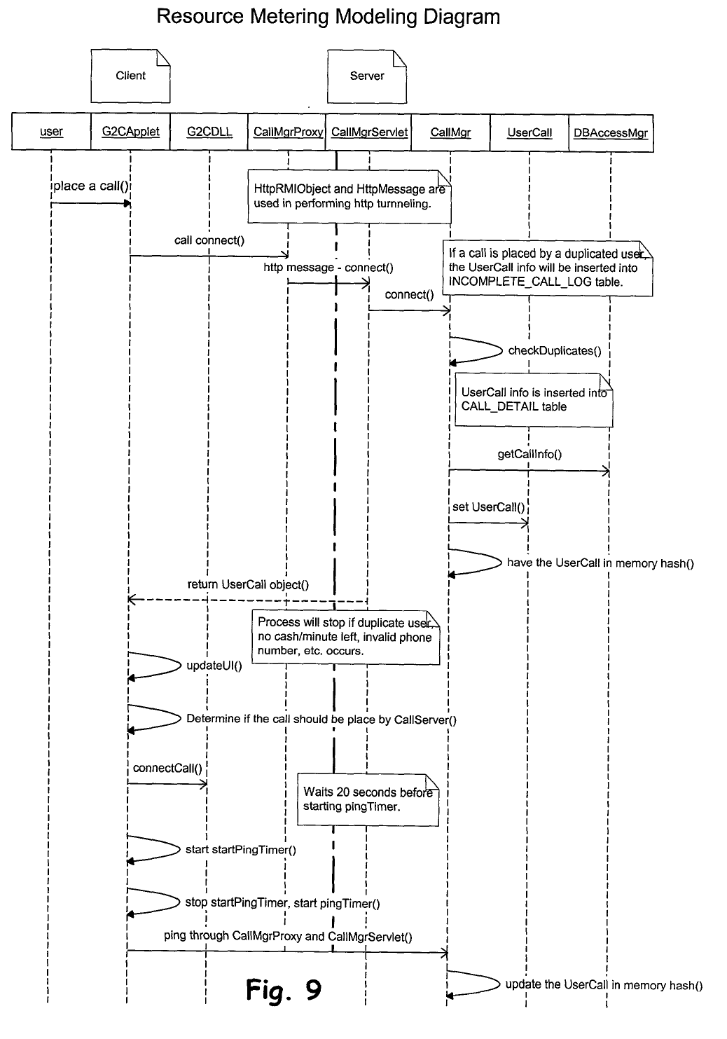

FIG. 9 is a modeling diagram for resource metering, according to an exemplary embodiment. FIG. 9 is provided as an example of a browser based VoIP PC-to-phone application. The VoIP application (G2Capplet) implements the resource metering process for communicating with the billing server (CallMgr Servlet) to update service progress and calculate charges for a PC-to-phone application. Other resource metering sequences may be employed for PC-to-phone applications, as well as for other distributed metering system applications.

C. Termination

The billing client 702 may send a message to the billing server 710 indicating that the billing client 702 is terminating the service. The end user may terminate the service by hitting an end icon or a button on the display 718. Other methods of terminating the service may be accomplished by using other client components, such as a phone pad, a keyboard, or a video screen.

The service may be terminated when the billing server 710 no longer detects the RUU from the billing component 716. The billing server 710 may terminate the service after not detecting the RUU for a specified period of time. For example, the network 714 may drop the billing client's 702 connection to the at least one gateway 706, 708.

If the end user has a pre-paid account, the billing server 710 may terminate the service when funds in the account have been substantially depleted. The billing server 710 may provide the end user with notice of the impending termination and allow the end user to fund the account through the billing client 702. By allowing the billing server 710 to terminate service when pre-paid accounts have been depleted, the service provider may reduce a risk of non-payment of services.

When either the billing client 702 or the billing server 710 has terminated service, the billing server 710 may remove the end user from the collection of active end users located on the service manager 724 and store the end user data in the at least one database 722. The billing client 702 may retrieve the data the next time the billing client 702 runs the initialization routines. The billing server 710 may use the data in the at least one database 722 to generate a bill for the service, which may be submitted to the end user for payment.

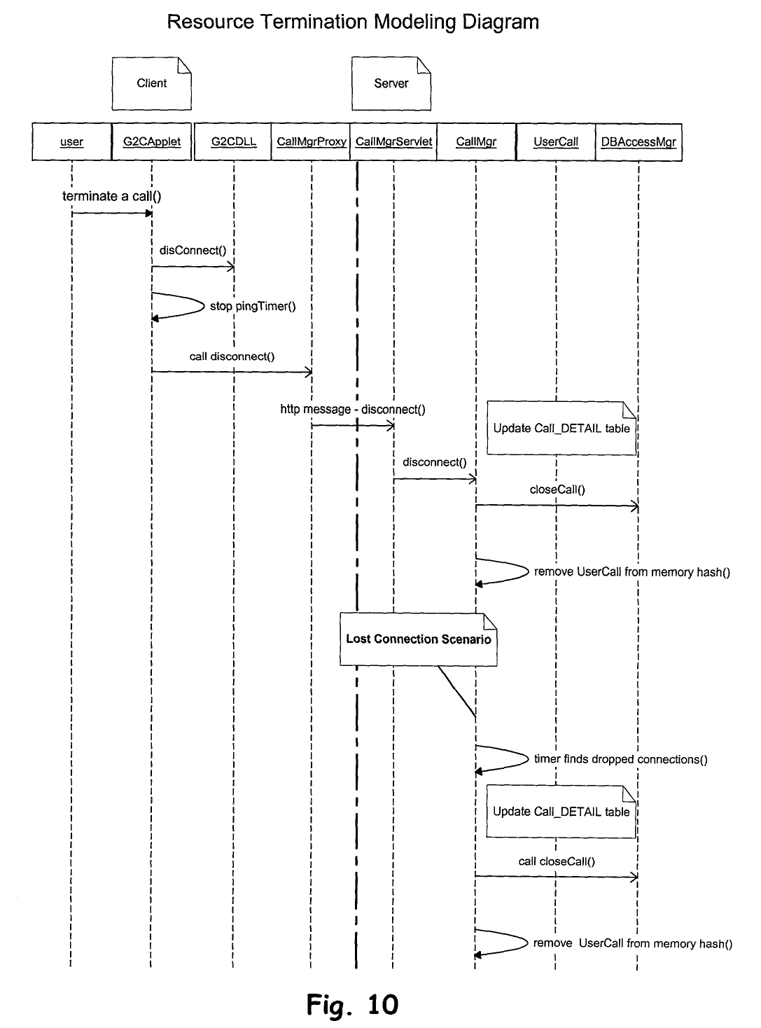

FIG. 10 is a modeling diagram for resource termination, according to an exemplary embodiment. FIG. 10 is provided as an example of a browser based VoIP PC-to-phone application. The VoIP application (G2Capplet) implements the resource termination process for communicating with the billing server (CallMgr Servlet) to terminate the service and calculate final charges for a PC-to-phone application. Other resource termination sequences may be employed for PC-to-phone applications, as well as for other distributed metering system applications.

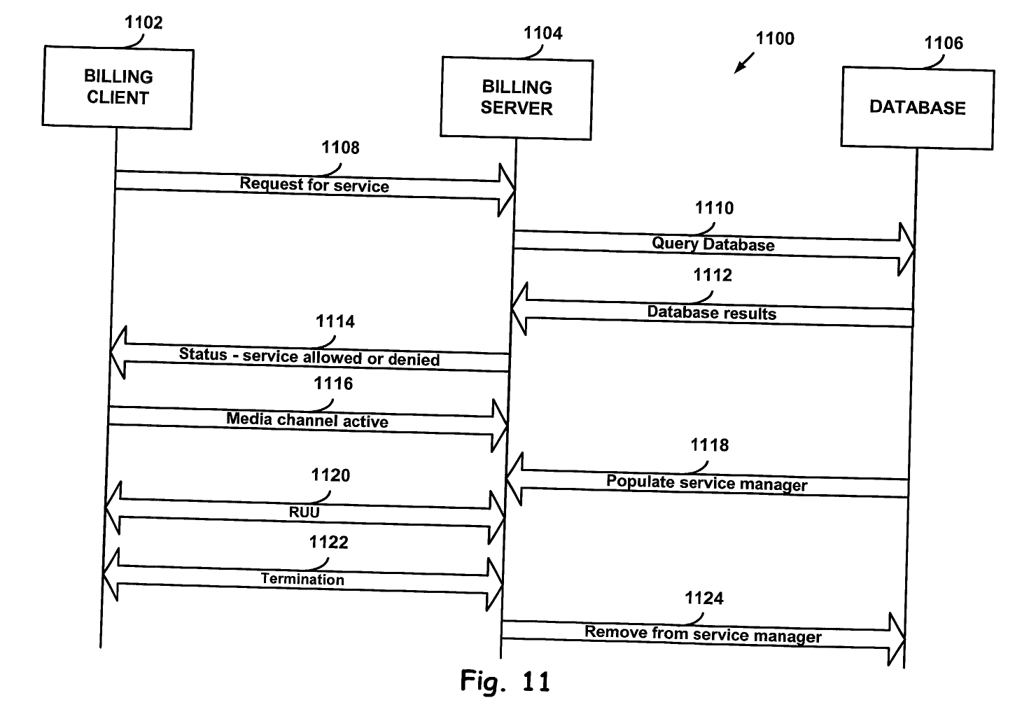

FIG. 11 is a message flow diagram illustrating a method 1100 for providing distributed resource metering system service, according to an exemplary embodiment. The entities shown as transmitting and receiving messages include a billing client 1102, a billing server 1104, and at least one database 1106. Various messages to be set forth below may be transmitted or received by entities other than what is described. For example, the billing client 1102 may either have lower level components or may be included within higher level components, some of which may be involved in the transmission of messages, according to alternative embodiments. In addition, other messages may be transmitted or received that are not depicted in FIG. 11.

The billing client 1102 may transmit a request for service 1108 to the billing server 1104. The request for service 1108 may include a type of service requested and an end user identification code. The request for service may also include end user name, end user preferences, and status information. In an exemplary embodiment, the request for service may be in the format of a serialized encrypted Java object; however, other message formats may be employed.

The billing server 1104 may receive the request for service 1108 from the billing client 1102. The billing server 1104 may query 1110 the at least one database 1106 to determine whether the billing client 1102 is authorized to make a request and, if so, whether the type of service requested is available. The at least one database 1106 may provide the billing server 1104 with database results 1112.

The billing server 1104 may send a status message 1114 to the billing client 1102. The status message 1114 may indicate that the billing client 1102 is not authorized for the service requested. The billing client 1102 may not be authorized for a variety of reasons, such as an invalid end user identification code, an unfunded end user account, or lack of access to the type of service requested. If the status message 1114 indicates that the billing client 1102 is authorized for the service requested, the billing server 1104 may provide the billing client 1102 with information regarding how to communicate with a gateway, an application server, or another billing client.

The billing client 1102 may access a service using the gateway, or directly contacting the application server or other billing client. Once the billing client 1102 has connected with the gateway, the application server, or other billing client, the billing client 1102 may send a media channel active message 1116 to the billing server 1104. The billing server 1104 may populate a service manager 1118 using information obtained from the at least one database 1106.

The billing client 1102 may transmit a RUU 1120 to the billing server 1104 at a billing interval rate. In an exemplary embodiment, the RUU is transmitted to the billing server 1104 every minute. This time may be increased or decreased based on the billing interval employed by the distributed resource metering system. If the RUU stops, the billing client 1102 or the gateway may no longer be connected to the network.

The billing server 1104 may continue monitoring the billing client 1102 until the RUU stops, the billing server 1104 receives a message from the billing client 1102 to terminate the service, or the billing client 1102 no longer has finds in its account. A termination message 1122 may originate from the billing client 1102 or the billing server 1104 depending upon how the service was terminated.

The billing server 1104 may remove the billing client 1102 from the service manager 1124 and store the record in the at least one database 1106. The billing client 1102 may retrieve the record the next time the billing client 1102 runs initialization routines. The billing server 1104 may retrieve the record from the at least one database 1106 to generate an invoice itemizing the costs of the service to the end user.

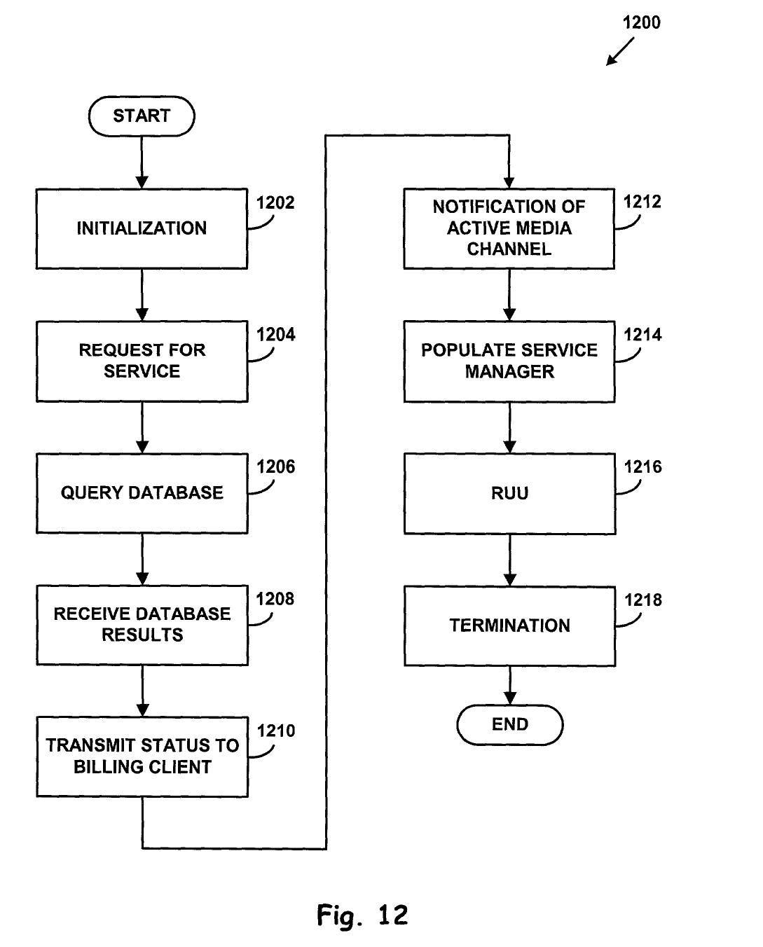

FIG. 12 is a simplified flow diagram illustrating a method 1200 for providing distributed resource metering system service, according to an exemplary embodiment. In 1202, the billing client 102 may be initialized. This may occur when the end user turns on the billing client 102 or when the billing client 102 loses and then finds its signal. In 1204, the billing client 102 may send a request for service to the billing server 104. In 1206, the billing server 104 may query the at least one database 106 to determine if the billing client 102 is authorized for the service. In 1208, the billing server 104 receives the results of the at least one database 106 query.

In 1210, the billing server 104 transmits the status of the at least one database 106 query to the billing client 102. The status may include whether the billing client 102 is or is not authorized to use the service. If the billing client 102 is authorized to use the service, the billing client may access a media channel through the gateway, or directly contact the application server or other billing client. In 1212, the billing client 102 may notify the billing server 104 that the billing client 102 has connected with the gateway, application server, or other billing client. In 1214, the billing server 104 may populate the service manager 404 with data obtained from the at least one database 106. In 1216, the billing server 104 may monitor the communication between the billing client 102, and either the service or the other billing client using the RUU. In 1218, either the billing client 102 or the billing server 104 may terminate the service. Much of the functionality described with reference to FIGS. 1-11 may also be included in the method 1200.

In view of the wide variety of embodiments to which the principles of the invention can be applied, it should be understood that the illustrated embodiments are exemplary only, and should not be taken as limiting the scope of the present invention. For example, more or fewer elements or components may be used in the block diagrams. In addition, the present invention can be practiced with a combination of software and hardware.

We claim:

1. A distributed resource metering system for billing, comprising in combination:
a billing component located on a billing client; and
at least one billing server.

2. The system of claim 1, further comprising at least one database.

3. The system of claim 1, wherein the billing client and the billing server are linked to a network.

4. The system of claim 3, where in the network is a packet-switched network.

5. The system of claim 1, wherein the billing client is a device that is capable of accessing a network, and wherein the billing client is selected from the group consisting of a personal computer, a mobile phone, a wireless handheld device, and a packet-switched telephone.

6. The system of claim 1, wherein the billing client contains a display.

7. The system of claim 6, wherein the display contains a Graphical User Interface.

8. The system of claim 6, wherein the display depicts substantially real time billing data.

9. The system of claim 6, wherein the display depicts account data.

10. The system of claim 6, wherein the display is operable to allow an end user to fund an account.

11. The system of claim 1, wherein the billing component contains software providing a communication means for the billing client and the billing server.

12. The system of claim 11, wherein the software is a Java applet.

13. The system of claim 11, wherein the software is encrypted.

14. The system of claim 11, wherein the at least one billing server transfers a latest version of the software onto the billing component.

15. The system of claim 1, wherein the at least one billing server is an application server.

16. The system of claim 1, wherein the at least one billing server is operable to provide application billing.

17. The system of claim 1, wherein the at least one billing server comprises:
a billing manager; and
a service manager.

18. The system of claim 17, wherein the billing manager is operable to manage data between the billing client and at least one database.

19. The system of claim 17, wherein the service manager consists of a collection containing a list of substantially all active end users.

20. The system of claim 17, wherein the service manager contains data identifying an end user, a type of service, a rate, an endpoint, and a duration.

21. The system of claim 1, wherein the at least one billing server monitors communication between the billing client and a gateway.

22. The system of claim 21, wherein a Resource Utilization Update is employed to monitor the communication between the billing client and the gateway.

23. The system of claim 22, wherein the Resource Utilization Update contains substantially all data needed to populate a service manager.

24. The system of claim 1, wherein Hypertext Transfer Protocol provides a secured communication means for the billing client and the at least one billing server.

25. The system of claim 1, wherein the at least one billing server includes a primary billing server and a secondary billing server.

26. The system of claim 25, wherein the secondary billing server is substantially the same as the primary billing server.

27. The system of claim 25, wherein the primary billing server and the secondary billing server are operable to access at least one database.

28. The system of claim 25, wherein the billing client communicates with the secondary billing server when the primary billing server is unavailable.

29. The system of claim 2, wherein the at least one database comprises:
a rating database containing rate information;
a presence database containing network connection information;
an account database containing account information; and
a service database containing service information.

30. A distributed resource metering system for billing, comprising in combination:
a billing component located on a billing client, wherein the billing client contains a display operable to depict substantially real time billing data;
at least one billing server, wherein the billing component provides a secured communication means for the billing client and the at least one billing server, wherein the at least one billing server includes a billing manager and a service manager, and wherein the at least one billing server monitors communication between the billing client and a gateway using a Resource Utilization Update; and
at least one database, wherein the billing manager is operable to manage data between the billing client and the at least one database.

31. The system of claim 30, wherein the billing client and the billing server are linked to a network.

32. The system of claim 31, wherein the network is a packet-switched network.

33. The system of claim 30, wherein the billing client is a device that is capable of accessing a network, and wherein the billing client is selected from the group consisting of a personal computer, a mobile phone, a wireless handheld device, and a packet-switched telephone.

34. The system of claim 30, wherein the at least one billing server includes a primary billing server and a secondary billing server, and wherein the billing client communicates with the secondary billing server when the primary billing server is unavailable.

35. The system of claim 30, wherein the at least one database comprises:
a rating database containing rate information;
a presence database containing network connection information;
an account database containing account information; and
a service database containing service information.

36. A method for providing distributed resource metering for billing, comprising in combination:
sending a request for a service to a billing server;
querying at least one database;
providing a status response to a billing client; and
monitoring communication between the billing client and a gateway.

37. The method of claim 36, further comprising terminating the service.

38. The method of claim 36, wherein the request for the service is a serialized encrypted Java object.

39. The method of claim 36, wherein communication between the billing client and the billing server uses HyperText Transfer Protocol and Transmission Control Protocol/Internet Protocol.

40. The method of claim 36, wherein the billing server transfers a latest version of software onto a billing component located on the billing client.

41. The method of claim 36, wherein the billing client uses the gateway to access a service.

42. The method of claim 41, wherein the service is accessed through a media channel, and wherein the media channel is selected from the group consisting of voice, video, instant messaging, Web browsing, and file downloading.

43. The method of claim 36, wherein the billing server verifies that the billing client is authorized to make the request for the service.

44. The method of claim 43, wherein authorization requires account funding for pre-paid accounts, and wherein an end user is operable to fund a pre-paid account, thereby allowing the billing server to authorize the billing client.

45. The method of claim 36, wherein the billing server provides gateway information to the billing client.

46. The method of claim 36, wherein the billing server monitors the communication between the billing client and the gateway using a Resource Utilization Update.

47. The method of claim 46, wherein the Resource Utilization Update contains substantially all data needed to populate a service manager.

48. The method of claim 46, wherein the Resource Utilization Update is a serialized Java object.

49. The method of claim 36, wherein the billing server maintains a service manager.

50. The method of claim 49, wherein the service manager contains data identifying an end user, a type of service, a rate, an endpoint, and a duration.

51. The method of claim 36, wherein an end user receives substantially real time billing data.

52. The method of claim 37, wherein the billing client terminates the service.

53. The method of claim 37, wherein the billing server terminates the service when an end user account is substantially zero.

54. The method of claim 37, wherein the billing server terminates the service when the billing client stops transmitting a Resource Utilization Update.

55. The method of claim 37, wherein the billing server may transfer data from a service manager to at least one database substantially after terminating the service.

56. The method of claim 36, further comprising generating a bill for the service.

57. The method of claim 56, wherein the bill for service provides application billing.

58. A method of providing real time billing data, comprising in combination:
downloading a billing component onto a billing client;
monitoring communication between the billing client and a gateway; and
updating billing data on a display substantially in real time, wherein the display is located on a billing client.

59. The method of claim 58, wherein the billing component is a Java applet.

60. The method of claim 58, wherein the billing client is a device that is capable of accessing a network, and wherein the billing client is selected from the group consisting of a personal computer, a mobile phone, a wireless handheld device, and a packet-switched telephone.

61. The method of claim 58, wherein a Resource Utilization Update is employed to monitor the communication between the billing client and the gateway.

62. The method of claim 58, wherein the display contains a Graphical User Interface.

63. The method of claim 58, wherein the display is operable to allow an end user to fund an account.

64. A system for providing distributed resource metering for billing, comprising in combination:
a means for sending a request for a service to a billing server;
a means for querying at least one database;
a means for providing a status response to a billing client; and
a means for monitoring communication between the billing client and a gateway.
